(19) United States
(12) Patent Application Publication
(10) Pub. No.: US 2026/0181421 A1
(43) Pub. Date: Jun. 25, 2026

(54) RADIO AREA DESIGN SUPPORT APPARATUS, RADIO AREA DESIGN SUPPORT METHOD AND PROGRAM

(71) Applicant: NTT, Inc., Tokyo (JP)

(72) Inventors: Toshiro NAKAHIRA, Tokyo (JP); Daisuke MURAYAMA, Tokyo (JP); So TAKATANI, Tokyo (JP); Takatsune MORIYAMA, Tokyo (JP)

(21) Appl. No.: 19/125,047

(22) PCT Filed: Nov. 9, 2022
(86) PCT No.: PCT/JP2022/041707

§ 371 Date: Apr. 28, 2025

(51) Int. Cl. H04W 24/02

(52) U.S. Cl. CPC H04W 24/02

(57) ABSTRACT

A radio area design support apparatus includes a reception power calculation unit that calculates, for each of a plurality of layouts having different numbers of base stations from each other with respect to arrangement of base stations regarding wireless communication, reception power of a case where a base station is arranged according to the layout at one or more points, a wireless parameter calculation unit that calculates, for each of the layouts, a wireless parameter to be set for the base station related to the layout based on a predetermined condition, a throughput calculation unit that calculates, for each of the layouts, an estimation value of throughput at the one or more points based on the reception power and the wireless parameter, and an evaluation unit that evaluates superiority or inferiority of the plurality of layouts based on at least one of the number of base stations or the estimation value, thereby enabling radio area design in consideration of communication quality or cost.

### TECHNICAL FIELD

The present invention relates to a radio area design support apparatus, a radio area design support method, and a program.

### BACKGROUND ART

To construct a coverage area of a wireless communication system, cell design for determining base station arrangement (installation location and antenna direction) is performed. In the cell design, a simulation of a service area is performed after the base station arrangement is selected, and a method of estimation by an experimental formula (Non Patent Literature 1) or a ray tracing method (Non Patent Literature 2) is used.

### CITATION LIST

### Non Patent Literature

Non Patent Literature 1: “Cell Design in Mobile Communication”, NTT DoComo Technical Journal vol. 2 no. 4, [online], Internet <https://www.nttdocomo.co.jp/binary/pdf/corporate/technology/rd/technical_journal/bn/vol2_4/vol2_4_035jp.pdf>
Non Patent Literature 2: “Ray-tracing Method Using Genetic Algorithm for Radio Wave Propagation Estimation”, NTT DoCoMo Technical Journal vol. 15 no. 3, [online], Internet <https://www.nttdocomo.co.jp/binary/pdf/corporate/technology/rd/technical_journal/bn/vol15_3/vol15_3_020jp.pdf>

### SUMMARY OF INVENTION

### Technical Problem

As a new use form of a wireless system, an increase in use for business in factories and the like is expected in the future. Unlike a best-effort-type service for consumers, it is considered that business services require a radio area design that can satisfy a required communication throughput. However, the conventional technology in which a simulation of a service area is performed after the base station arrangement is selected has a problem that the cell design for wireless base stations based on whether the required communication throughput is satisfied cannot be performed. In addition, device cost cannot be considered.

The present invention has been made in view of the above points, and an object thereof is to enable radio area design in consideration of communication quality or cost.

### Solution to Problem

Therefore, to solve the above-described problem, a radio area design support apparatus includes: a reception power calculation unit configured to calculate, for each of a plurality of layouts having different numbers of base stations from each other with respect to arrangement of base stations regarding wireless communication, reception power of a case where a base station is arranged according to the layout at one or more points; a wireless parameter calculation unit configured to calculate, for each of the layouts, a wireless parameter to be set for the base station related to the layout based on a predetermined condition; a throughput calculation unit configured to calculate, for each of the layouts, an estimation value of throughput at the one or more points based on the reception power and the wireless parameter; and an evaluation unit configured to evaluate superiority or inferiority of the plurality of layouts based on at least one of the number of base stations or the estimation value.

### Advantageous Effects of Invention

It is possible to enable radio area design in consideration of communication quality or cost.

### BRIEF DESCRIPTION OF DRAWINGS

FIG. 1 is a diagram illustrating a hardware configuration example of a radio area design support apparatus 10 in an embodiment of the present invention.

FIG. 2 is a diagram illustrating a functional configuration example of the radio area design support apparatus 10 according to the embodiment of the present invention.

FIG. 3 is a flowchart for describing an example of a processing procedure of radio area design processing in a first embodiment.

FIG. 4 is a table illustrating an example of a cell design condition A.

FIG. 5 is a table illustrating an example of a radio wave propagation calculation condition B.

FIG. 6 is a table illustrating an example of a wireless parameter calculation condition C.

FIG. 7 is a table illustrating an example of a throughput calculation condition D.

FIG. 8 is a flowchart for describing an example of a processing procedure of radio area design processing in a second embodiment.

### DESCRIPTION OF EMBODIMENTS

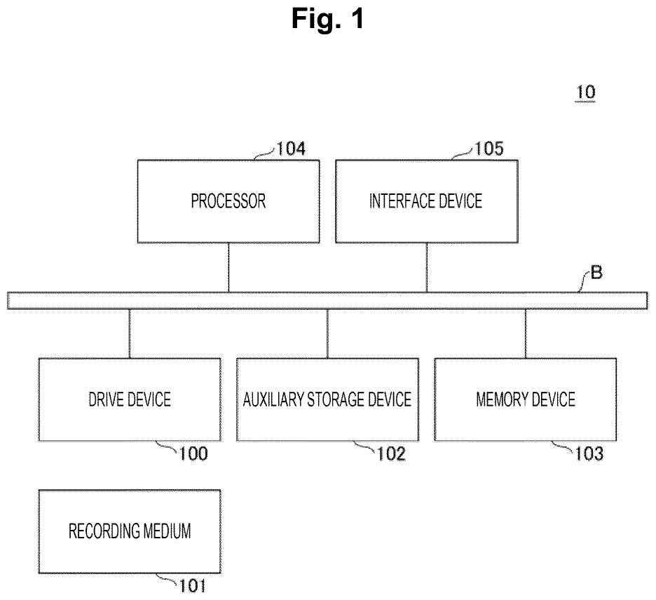

Hereinafter, embodiments of the present invention will be described with reference to the drawings. FIG. 1 is a diagram illustrating a hardware configuration example of a radio area design support apparatus 10 in an embodiment of the present invention. The radio area design support apparatus 10 in FIG. 1 includes a drive device 100, an auxiliary storage device 102, a memory device 103, a processor 104, an interface device 105, and the like, which are connected to each other by a bus B.

A program for implementing processing in the radio area design support apparatus 10 is provided by a recording medium 101 such as a CD-ROM. When the recording medium 101 storing the program is set in the drive device 100, the program is installed from the recording medium 101 to the auxiliary storage device 102 via the drive device 100. Note that the program is not necessarily installed from the recording medium 101 and may be downloaded from another computer via a network. The auxiliary storage device 102 stores the installed program and also stores necessary files, data, and the like.

In a case where a command to start the program is issued, the memory device 103 reads the program from the auxiliary storage device 102 and stores the program. The processor 104 is a CPU or a graphics processing unit (GPU), or the CPU and the GPU, and executes a function related to the radio area design support apparatus 10 according to the program stored in the memory device 103. The interface device 105 is used as an interface for connection to the network.

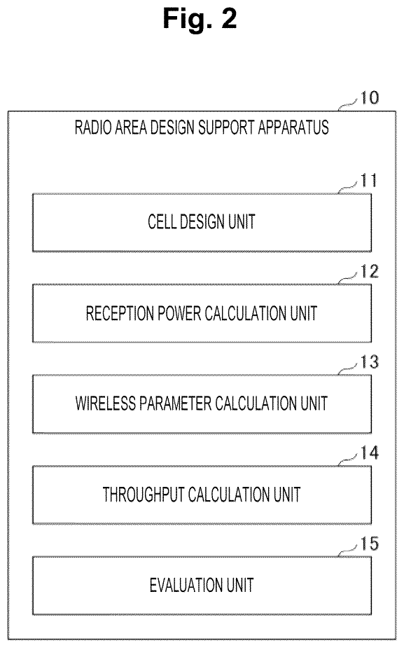

FIG. 2 is a diagram illustrating a functional configuration example of the radio area design support apparatus 10 according to the embodiment of the present invention. In FIG. 2, the radio area design support apparatus 10 includes a cell design unit 11, a reception power calculation unit 12, a wireless parameter calculation unit 13, a throughput calculation unit 14, an evaluation unit 15, and the like. Each of these units is implemented by having the processor 104 execute one or more programs installed in the radio area design support apparatus 10.

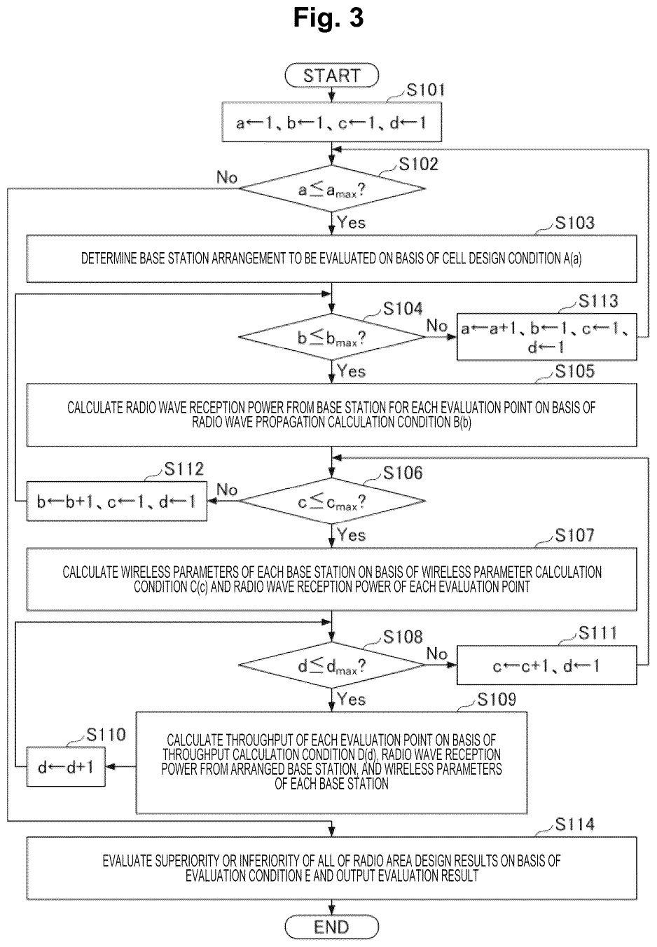

Hereinafter, a processing procedure executed by the radio area design support apparatus 10 will be described. FIG. 3 is a flowchart for describing an example of a processing procedure of radio area design processing. Note that, in the present embodiment, the cell design refers to determining arrangement t (installation location and antenna direction) of a base station for constructing a coverage area of a wireless system, and radio area design refers to determining wireless parameters (transmission output, channel, and the like) set for the base station in addition to the cell design.

In step S101, the cell design unit 11 substitutes 1 for each of variables a, b, c, and d.

Subsequently, the cell design unit 11 determines whether a value of “a” is equal to or less than aₘₐₓ (S102). aₘₐₓ is an upper limit value of “a” and is set in advance.

In a case where the value of a is equal to or less than aₘₐₓ (Yes in S102), the cell design unit 11 determines base station arrangement (base station layout) to be evaluated with respect to arrangement of base stations in a target area based on a cell design condition A(a) (S103). The target area refers to a geographical range for which a radio area is designed. Further, the cell design condition is information indicating a constraint condition in cell design.

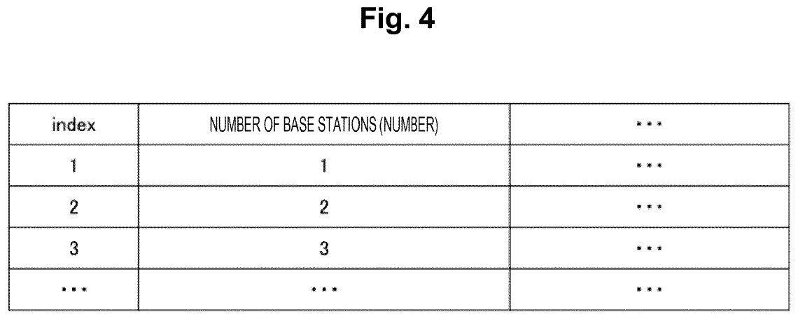

FIG. 4 is a table illustrating an example of a cell design condition A. As illustrated in FIG. 4, the cell design condition A includes a plurality of cell design conditions. The above aₘₐₓ is the total number of the cell design conditions included in the cell design condition A. The cell design condition A(a) indicates the a-th (index is “a”) cell design condition in the cell design condition A. FIG. 4 illustrates the number of base stations as a component of the cell design condition. That is, FIG. 4 illustrates a plurality of base station conditions, among which the numbers of base stations are different from each other. The number of base stations is the number of base stations to be arranged. The cell design condition may include items other than the number of base stations. For example, the cell design condition may include items such as a direction of a base station (a direction of an antenna), a type of a system, information of a wireless base station device, a place where a wireless base station can be arranged in the target area, a size and a shape of the target area, and a range (position) and a material of a structure. Among these items, effective items may be different in each cell design condition.

Note that the determination of the base station arrangement based on the cell design condition (satisfying the cell design) may be performed based on a known technique.

Subsequently, the reception power calculation unit 12 determines whether the value of b is equal to or less than bₘₐₓ (S104). bₘₐₓ is an upper limit value of b and is set in advance.

In a case where the value of b is equal to or less than bₘₐₓ (Yes in S104), the reception power calculation unit 12 calculates radio wave reception power from any one of the base stations for each of one or more evaluation points in the target area based on a radio wave propagation calculation condition B (b) (S105). The evaluation point refers to a point set in advance as a place where wireless communication is required to be possible in the target area. For example, a place where use of a terminal is assumed is set as the evaluation point.

Since the radio wave reception power from any one of the base stations is calculated for each evaluation point, one radio wave reception power is calculated for one evaluation point. For example, the reception power calculation unit 12 calculates the radio wave reception power from all the base stations and selects one of the radio wave reception powers, for each evaluation point. The radio wave reception power selected for a certain evaluation point may be, for example, a maximum value of the radio wave reception power calculated for the evaluation point. Alternatively, in a case where wireless communication systems are mixed between the base stations, a priority ranking may be given to the wireless communication systems, and one radio wave reception power in consideration of the priority ranking may be selected. By selecting one radio wave reception power for each evaluation point, the base station at a connection destination is selected for each evaluation point.

Note that an arrangement position of each base station in the target area in calculation of the radio wave reception power is an arrangement position determined in step S103 that has been executed most recently. Further, the radio wave propagation calculation condition is a condition related to a method of calculating the radio wave reception power from the base station.

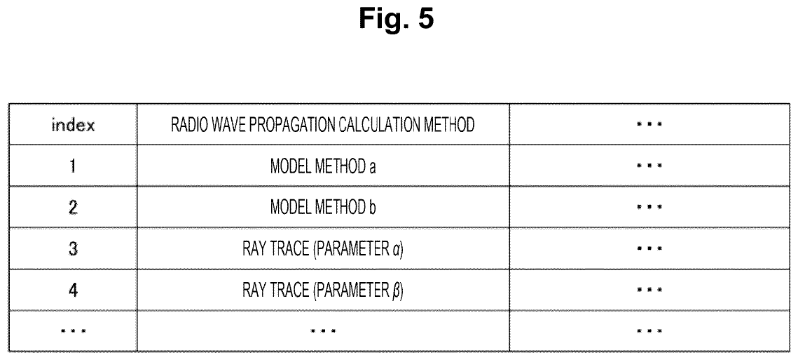

FIG. 5 is a table illustrating an example of the radio wave propagation calculation condition B. As illustrated in FIG. 5, the radio wave propagation calculation condition B includes a plurality of radio wave propagation calculation methods. bₘₐₓ is the total number of radio wave propagation calculation methods included in the radio wave propagation calculation condition B. The radio wave propagation calculation condition B (b) indicates the b-th (index is b) radio wave propagation calculation method in the radio wave propagation calculation condition B.

Subsequently, the wireless parameter calculation unit 13 determines whether the value of c is equal to or less than cₘₐₓ (S106). cₘₐₓ is an upper limit value of c and is set in advance.

In a case where the value of c is equal to or less than cₘₐₓ (Yes in S106), the wireless parameter calculation unit 13 calculates the wireless parameters set for each base station based on a wireless parameter calculation condition C(c) and (the maximum value of) the radio wave reception power from the base station at each evaluation point (S107).

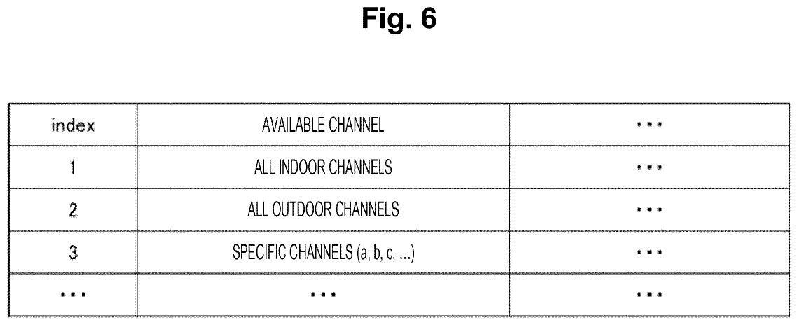

FIG. 6 is a table illustrating an example of the wireless parameter calculation condition C. As illustrated in FIG. 6, the wireless parameter calculation condition C includes a plurality of available channels. Regarding the above-described cₘₐₓ, the wireless parameter calculation condition C(c) that is the total number of available channels included in the wireless parameter calculation condition C indicates the c-th (index is c) available channel in the wireless parameter calculation condition C.

The wireless parameter calculation unit 13 calculates a frequency channel to be allocated to each base station from a range of the available channels indicated by the wireless parameter calculation condition C(c).

Subsequently, the throughput calculation unit 14 determines whether the value of d is equal to or less than dₘₐₓ (S108). dₘₐₓ is an upper limit value of d and is set in advance.

In a case where the value of d is equal to or less than dₘₐₓ (Yes in S108), the throughput calculation unit 14 calculates, for each evaluation point, an estimation value of throughput of a wireless link with the base station at the connection destination of the evaluation point based on a throughput calculation condition D(d), the radio wave reception power of each evaluation point, and the wireless parameters of each base station (S109). The throughput calculation condition D is a condition for calculating the estimation value of throughput.

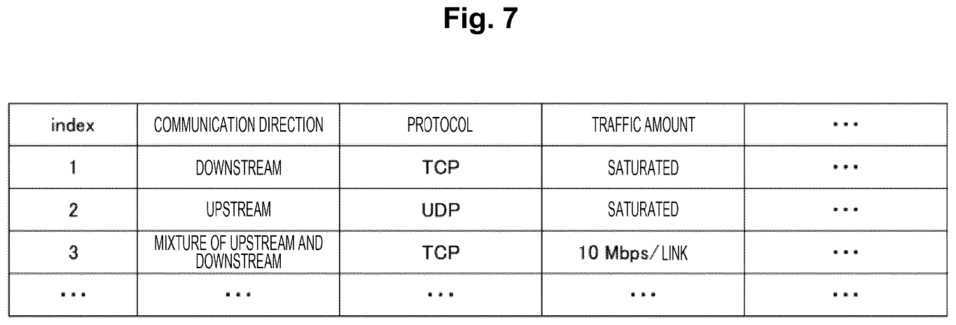

FIG. 7 is a table illustrating an example of the throughput calculation condition D. As illustrated in FIG. 7, the throughput calculation condition D includes a plurality of conditions as conditions for calculating the estimation value of the throughput. Regarding the above-described dₘₐₓ, the throughput calculation condition D(d) that is the total number of throughput calculation conditions included in the throughput calculation condition D indicates the d-th (index is d) throughput calculation condition in the throughput calculation condition D. In the example of FIG. 7, the throughput calculation condition includes “communication direction”, “protocol”, “traffic amount”, and the like. Here, “mixture of upstream and downstream” in the communication direction means calculation of the estimation value of each of upstream throughput and downstream throughput in a case where upstream traffic and downstream traffic are simultaneously applied. Further, the “traffic amount” is a value of traffic applied to the wireless link. The calculated estimation value of the throughput is an amount of data estimated to actually flow (for example, a value obtained by simulation).

Subsequently, the throughput calculation unit 14 adds 1 to d (S110), and returns to step S108. As a result, when the value of d exceeds dₘₐₓ (No in S108), the throughput calculation unit 14 adds 1 to c and substitutes 1 for d (S111), and returns to step S106. As a result, when the value of c exceeds cₘₐₓ (No in S106), the wireless parameter calculation unit 13 adds 1 to b and substitutes 1 for c and d (S112), and returns to step S104. As a result, when the value of b exceeds bₘₐₓ (No in S104), the reception power calculation unit 12 adds 1 to a and substitutes 1 for b, c, and d (S113), and returns to step S102. As a result, when the value of a exceeds aₘₐₓ (No in S102), the processing proceeds to step S114. That is, for all (all sets of) combinations of the cell design condition, the radio wave propagation calculation method, the wireless parameter calculation condition, and the throughput calculation condition, combinations (hereinafter referred to as “radio area design results”) of the base station arrangement result (S103), the calculation result of the radio wave reception power at each evaluation point (S105), the calculation result of the wireless parameters of each base station (S107), and the calculation result of the estimation value of the throughput of each evaluation point (S109) are obtained, and then step S114 is executed.

In step S114, the evaluation unit 15 evaluates superiority or inferiority of the radio area design results based on an evaluation condition E, and outputs an evaluation result. The evaluation condition E refers to information for narrowing down the base station arrangement result in stages based on the following two conditions:
(1) a communication quality satisfaction level is equal to or greater than a target value; and
(2) a total cost of equipment is minimum.

Here, the communication quality satisfaction level is an index indicating the degree of satisfaction with respect to a threshold set in advance for the throughput for each evaluation point. For example, a value (a value of 0 or more and 1 or less) obtained by dividing the estimation value of the throughput by the target value may be set as the communication quality satisfaction level. The target value of the communication quality satisfaction level refers to a threshold set for the communication quality satisfaction level.

Further, the total cost of equipment may be calculated based on, for example, a combination of the number of required base stations and the number of required antennas.

Note that the base station arrangement result may be narrowed down based on only one of the above (1) and (2). Furthermore, the communication quality satisfaction level and the total cost of equipment may be evaluated in stages by sequentially evaluating a plurality of conditions. For example, one base station arrangement result may be selected based on (2) after narrowing down the results based on (1).

For example, the evaluation unit 15 outputs a set of radio area design results (the base station arrangement result, the radio wave reception power related to the base station arrangement result, the wireless parameters, and the estimation value of the throughput) selected based on the above (1) and (2).

As described above, according to a first embodiment, it is possible to efficiently perform the radio area design based on the satisfaction degree with the communication quality target value and the device cost. That is, it is possible to enable the radio area design in consideration of the communication quality of the cost.

Next, a second embodiment will be described. In the second embodiment, differences from the first embodiment will be described. Points not specifically mentioned in the second embodiment may be similar to those in the first embodiment.

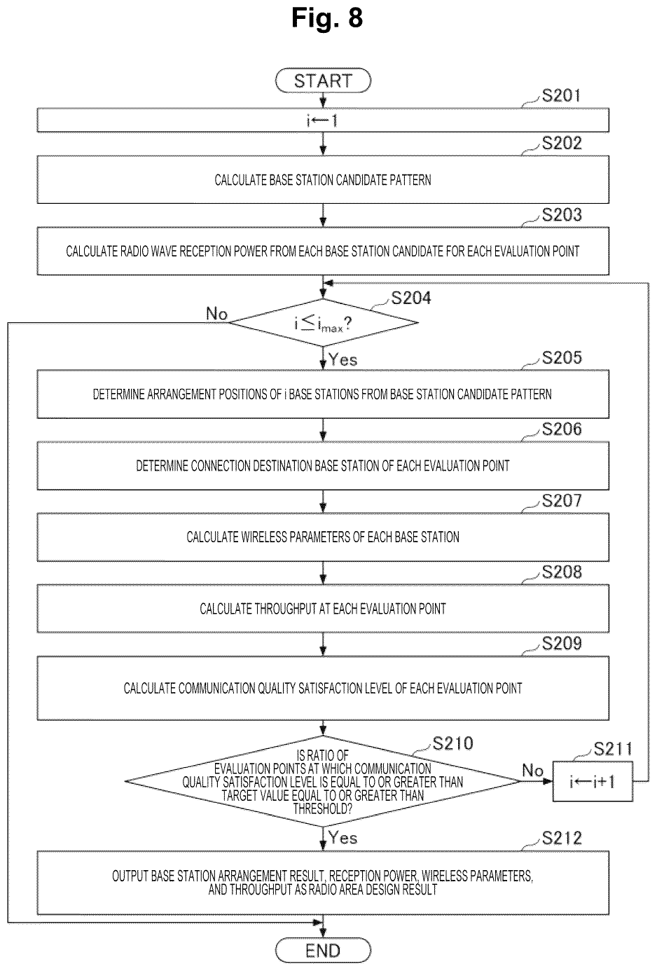

FIG. 8 is a flowchart for describing an example of a processing procedure of radio area design processing in the second embodiment.

In step S201, a reception power calculation unit 12 substitutes 1 for a variable i.

Subsequently, the reception power calculation unit 12 calculates a set (hereinafter referred to as “base station candidate patterns”) of a plurality of candidates (hereinafter referred to as “base station candidates”) related to an arrangement position of a base station with respect to a target area (S202). For example, in a case where the target area is modeled in a rectangular shape, the reception power calculation unit 12 may calculate coordinates of the respective candidates so as to be located at equal intervals in an x-axis (for example, an axis on a long side) direction and a y-axis (for example, an axis on a short side) direction. Alternatively, the reception power calculation unit 12 may randomly calculate the coordinates of each candidate. Alternatively, the coordinates of each candidate may be calculated in consideration of a constraint condition (unarrangeable place or the like) regarding the arrangement of the base station in the target area. Alternatively, the coordinates of each candidate may be calculated by another method, or the coordinates of each candidate may be a given value.

Subsequently, the reception power calculation unit 12 calculates radio wave reception power in a case where the base station is arranged in each base station candidate for each evaluation point in the target area (S203). Therefore, pieces of the radio wave reception power corresponding to the number of base station candidates are calculated for one evaluation point. Note that a method of calculating the radio wave reception power at the evaluation point from the base station candidate may be similar to the method of calculating the radio wave reception power at the evaluation point from the base station in step S105 of FIG. 3. Note that, here, the radio wave reception power is calculated based on one predetermined radio wave propagation calculation condition set in advance. The radio wave propagation calculation condition may or may not be any of the radio wave propagation calculation conditions constituting a radio wave propagation calculation condition B.

Subsequently, a cell design unit 11 determines whether the value of the variable i is equal to or less than iₘₐₓ (S204). iₘₐₓ is an upper limit value of the number of times of searching for a radio area design result that satisfies a target of a communication quality satisfaction level, and is set in advance.

In a case where the value of the variable i is equal to or less than iₘₐₓ (Yes in S204), the cell design unit 11 determines arrangement positions of i base stations (a layout of the i base stations) from the base station candidate patterns (S205). That is, i base station candidates are selected as arrangement destinations of the base station. Hereinafter, the selected base station candidates are referred to as “selected base station candidates”. Further, a set of the selected base station candidates is referred to as a “base station arrangement result”. Note that the selection of the arrangement positions of the i base stations may be performed based on a cell design condition in which the number of base stations is i in a cell design condition A.

Subsequently, the cell design unit 11 determines, for each evaluation point, one selected base station candidate (hereinafter referred to as a “connection destination candidate”) to be a connection destination at the evaluation point (S206). The connection destination candidate of a certain evaluation point may be, for example, a selected base station candidate having the maximum radio wave reception power calculated for the evaluation point. Alternatively, in a case where the wireless communication systems are mixed between the base stations, a priority ranking may be given to the wireless communication systems, and one selected base station candidate may be determined in consideration of the priority ranking.

Subsequently, a wireless parameter calculation unit 13 calculates wireless parameters for the base station related to each connection destination candidate based on one predetermined wireless parameter calculation condition set in advance and the radio wave reception power from the connection destination candidate at each evaluation point (S207). The predetermined wireless parameter calculation condition may be any of wireless parameter calculation conditions of a wireless parameter calculation condition C (FIG. 6) or another condition.

Subsequently, a throughput calculation unit 14 calculates an estimation value of throughput of a wireless link with the base station related to each connection destination candidate for each evaluation point based on the one predetermined throughput calculation condition set in advance, the radio wave reception power of each evaluation point, and the wireless parameters of the base station related to each connection destination candidate (S208). The one predetermined throughput calculation condition may be any condition in a throughput calculation condition D (FIG. 7) or another condition.

Subsequently, an evaluation unit 15 calculates a communication quality satisfaction level of each evaluation point based on the estimation value of the throughput of each evaluation point (S209). Definition of the communication quality satisfaction level may be similar to that of the first embodiment.

Subsequently, the evaluation unit 15 determines whether a ratio of the evaluation points at which the communication quality satisfaction level is equal to or greater than a target value is equal to or greater than a threshold (S210). For example, when the threshold is 100%, it is determined whether the communication quality satisfaction level is equal to or greater than the target value at all the evaluation points.

In a case where the ratio of the evaluation points, at which the communication quality satisfaction level is equal to or greater than the target value, is equal to or greater than the threshold (Yes in S210), the evaluation unit 15 outputs a combination of the base station arrangement result, the radio wave reception power of each evaluation point, the wireless parameters, and the estimation value of the throughput at present, as the radio area design result (S212).

In a case where the ratio of the evaluation points, at which the communication quality satisfaction level is equal to or greater than the target value, is less than the threshold (No in S210), the evaluation unit 15 adds 1 to i (S211). In this case, step S204 and the subsequent steps are executed again. By repeating step S204 and the subsequent steps, superiority or inferiority of the radio area design based on a plurality of cell design results (a plurality of layouts having different numbers of base stations from each other) are evaluated based on device cost and the communication quality satisfaction level. That is, since a case where the number of base stations is smaller is preferentially evaluated (in a previous order), the case where the device cost is lower is more highly evaluated.

As a result of the repetition of and after step S204, in a case where i exceeds iₘₐₓ (No in S211), step S212 is not executed and the processing procedure of FIG. 8 ends.

As described above, according to the second embodiment, the radio area design is not exhaustively searched, unlike the first embodiment, but the radio area design can be efficiently searched for, compared to the first embodiment. In addition, it is possible to perform radio area design in consideration of the communication quality or the cost, similarly to the first embodiment.

Note that, in each of the above embodiments, a plurality of wireless systems and methods may be mixed.

Although the embodiments of the present invention have been described in detail above, the present invention is not limited to such specific embodiments, and various modifications and changes can be made within the scope of the gist of the present invention described in the claims.

### REFERENCE SIGNS LIST

10 Radio area design support apparatus
11 Cell design unit
12 Reception power calculation unit
13 Wireless parameter calculation unit
14 Throughput calculation unit
15 Evaluation unit
100 Drive device
101 Recording medium
102 Auxiliary storage device
103 Memory device
104 Processor
105 Interface device
B Bus

1. A radio area design support apparatus comprising:
a processor; and
a memory that includes instructions, which when executed, cause the processor to execute:
calculating, for each of a plurality of layouts having different numbers of base stations from each other with respect to arrangement of base stations regarding wireless communication, reception power of a case where a base station is arranged according to the layout at one or more points;
calculating, for each of the layouts, a wireless parameter to be set for the base station related to the layout based on a predetermined condition;
calculating, for each of the layouts, an estimation value of throughput at the one or more points based on the reception power and the wireless parameter; and
evaluating superiority or inferiority of the plurality of layouts based on at least one of the number of base stations or the estimation value.

2. The radio area design support apparatus according to claim 1, wherein
the calculating of the reception power includes calculating a plurality of sets of the reception power based on a plurality of conditions for each of the layouts,
the calculating of the wireless parameter includes calculating a plurality of the wireless parameters based on the plurality of conditions for each of the layouts,
the calculating of the estimation value of throughput includes calculating a plurality of the estimation values based on the plurality of conditions for each of the layouts, and
the evaluating includes evaluating the superiority or inferiority of a combination of the plurality of layouts, the plurality of sets of reception power, the plurality of wireless parameters, and the plurality of estimation values.

3. The radio area design support apparatus according to claim 1, wherein
the wireless parameter includes a frequency channel.

4. A radio area design support method executed by a computer, the method comprising:
calculating, for each of a plurality of layouts having different numbers of base stations from each other with respect to arrangement of base stations regarding wireless communication, reception power of a case where a base station is arranged according to the layout at one or more points;
calculating, for each of the layouts, a wireless parameter to be set for the base station related to the layout based on a predetermined condition;
calculating, for each of the layouts, an estimation value of throughput at the one or more points based on the reception power and the wireless parameter; and
evaluating superiority or inferiority of the plurality of layouts based on at least one of the number of base stations or the estimation value.

5. A non-transitory computer-readable recording medium having computer-readable instructions stored thereon, which when executed, cause a computer including a memory and a processor to execute:
calculating, for each of a plurality of layouts having different numbers of base stations from each other with respect to arrangement of base stations regarding wireless communication, reception power of a case where a base station is arranged according to the layout at one or more points;
calculating, for each of the layouts, a wireless parameter to be set for the base station related to the layout based on a predetermined condition;
calculating, for each of the layouts, an estimation value of throughput at the one or more points based on the reception power and the wireless parameter; and
evaluating superiority or inferiority of the plurality of layouts based on at least one of the number of base stations or the estimation value.
